(19) United States
(12) Patent Application Publication
(10) Pub. No.: US 2015/0042764 A1
(43) Pub. Date: Feb. 12, 2015

(54) THREE-DIMENSIONAL HYPERSPECTRAL IMAGING SYSTEM

(71) Applicant: Board of Trustees of Michigan State University, East Lansing, MI (US)

(72) Inventors: Ning Xi, Okemos, MI (US); King Wai Chiu Lai, East Lansing, MI (US); Hongzhi Chen, East Lansing, MI (US); LiangLiang Chen, Lansing, MI (US); Bo Song, Lansing, MI (US)

(21) Appl. No.: 14/450,803

(22) Filed: Aug. 4, 2014

Related U.S. Application Data
(60) Provisional application No. 61/862,625, filed on Aug. 6, 2013.

(51) Int. Cl. H04N 13/02; H04N 13/00

(52) U.S. Cl. CPC H04N 13/0242; H04N 13/0253; H04N 13/0257; H04N 13/0007; H04N 2013/0077
USPC 348/47

(57) ABSTRACT

A method is provided for constructing a three-dimensional hyperspectral image using compressive sensing. The method includes: configuring on/off state of each mirror in an array of micromirrors in accordance with a pattern; capturing image data of a scene from a first point of view using a first photodetector; and capturing image data of the scene from second point of view using a second photodetector, where second point of view differs from the first point of view. The steps are repeated to obtain a series of measurement samples, where the array of micromirrors is configured in accordance with a pattern that differs amongst each measurement samples. By choosing different photodetectors with different band gap nanomaterials, the first and second photodetectors detects photons in the electromagnetic spectrum. As a result, the three-dimensional image also carry the spectrum information of the scene.

### CROSS-REFERENCE TO RELATED APPLICATIONS

This application claims the benefit of U.S. Provisional Application No. 61/862,625 filed on Aug. 6, 2013. The entire disclosure of the above application is incorporated herein by reference.

### GOVERNMENT RIGHTS

This invention was made with government support under N00014-04-1-0799 and N00014-10-1-0786 awarded by the Office of Naval Research. The government has certain rights in the invention.

### FIELD

The present disclosure relates to a technique for constructing a three-dimensional hyperspectral image using compressive sensing.

### BACKGROUND

Conventional digital imaging systems make use of an array of photosensors, or pixels, to measure the total intensity of the different light rays arriving at each individual pixel. Higher resolution images typically require a large number of pixels, which means a large amount of data per image. Also, most digital images contain a lot of redundant and duplicate information. For example, the background of a picture may have many pixels with the same color and texture information. Much of this redundant information ends up being discarded during the compression process, making these high resolution cameras very inefficient.

Single-pixel cameras, on the other hand, only have a single photosensor and make use of an array of tiny, independently controlled mirrors to capture the image point by point.

Compressive sensing techniques can be used to control the mirrors so that instead of taking a sample of each individual point, the particular samples to be taken are algorithmically determined so as to allow reconstruction of the final image with fewer measurement samples. In effect, the compression of the image data is being done before the pixels are recorded, rather than after as in a traditional multi-pixel camera.

While single-pixel imaging using compressive sensing has benefits over the multi-pixel array in that it reduces the amount of data captured, it suffers from the fact that it has to capture the data for a period of time. The multi-pixel array captures all the pixel samples at one time. Therefore, the speed of a single-pixel camera is largely a function of the capabilities of the photosensor.

Traditional silicon-based sensors have the benefit of being easy to manufacture, allowing for the creation of arrays with millions of pixels. However, traditional silicon based cameras have very slow response times. This is typically not an issue in multi-pixel imaging systems that sample all the pixels at one time, but this leads to very long image capture times on single-pixel imaging systems when the image is being taken for a period of time. Additionally, traditional infra-red (IR) sensors have high thermal noise and require cryogenic cooling; otherwise, the sensors would be flooded by their own thermal noise and environmental noise. Sensors made from nanomaterial, on the other hand, have very low thermal noise so they can perform imaging without external cooling. In addition, they have much faster response times because of their high electron-hole pair generation rate. However, they are difficult to manufacture so a large array of sensors made from nanomaterial is not practical.

Traditionally, hyperspectral imaging systems have made use of multi-pixel photosensor arrays. Since the photosensors in the array are fabricated in the same focal plane, there is a tradeoff between spatial resolution, the ability to determine small details of an object, and spectral resolution, the ability to resolve features in the electromagnetic spectrum. If the pixel size in the array is small to attain higher spatial resolution, the energy absorbed by each pixel is lower and, therefore, the accuracy of the final image is impacted more by noise. If the pixel size is larger, the energy absorbed by each pixel is higher, but the object in the final image is difficult to identify. With a single-pixel system and compressive sensing techniques, the spatial resolution of the image is not limited by the number pixels in the photosensor array. Instead it is determined by the number of single-pixel measurements that are taken. Likewise, the spectral resolution can be enhanced because a sensor made from nanomaterials having improved spectral response can be used.

Lastly, in a conventional imaging system, the photosensor array is only capable of measuring the intensity of different light rays hitting each point on the sensor plane, neglecting the direction from which the light ray came. This section provides background information related to the present disclosure which is not necessarily prior art.

### SUMMARY

This section provides a general summary of the disclosure, and is not a comprehensive disclosure of its full scope or all of its features.

A method is provided for constructing a three-dimensional hyperspectral image using compressive sensing. The method includes: configuring on/off state of each mirror in an array of micromirrors in accordance with a pattern; capturing image data of a scene from a first point of view using a first photodetector, where the image data is directed by the array of micromirrors to the first photodetector; and capturing image data of the scene from second point of view using a second photodetector, where second point of view differs from the first point of view and the image data is directed by the array of micromirrors to the second photodetector. The steps are repeated to obtain a series of measurement samples, where the array of micromirrors is configured in accordance with a pattern that differs amongst each measurement samples. A first image is constructed from the series of measurement samples captured by the first photodetector using compressive sensing while a second image is constructed from the series of measurement samples captured by the second photodetector using compressive sensing. A three-dimensional output image is then constructed from the first and second images, where the number of measurement samples is less than pixel of the output image. Additionally, a light field output image can be constructed by extending number of photodetectors that enable the reconstruction of multiple images.

In another aspect of this disclosure, a system is provided for constructing a three-dimensional hyperspectral image. The system includes: an array of micromirrors arranged to receive the electromagnetic radiation reflected from a scene, where each mirror in the array of micromirrors is selectively configurable between an on state and an off state, such that electromagnetic radiation directed by mirrors in an on state form image data from the scene and electromagnetic radiation directed by mirrors in an off state is excluded from the image data; a first photodetector is arranged to capture the image data reflected by the array of micromirrors from a first point of view; a second photodetector is arranged to receive the image data reflected by the array of micromirrors from a second point of view; and an image processor is configured to receive image data from the first and second photodetectors. The system may optionally include an infrared light source configured to project electromagnetic radiation towards the scene.

During operation, image data is captured by the first and second detectors over a series of measurements, where the on/off state of each mirror in the array of micromirrors is configured in accordance with a pattern that differ amongst each measurement in the series of measurements. Using compressive sensing, a first image is constructed from image data captured by the first photodector over the series of measurements and a second image is constructed from image data captured by the second photodetector over the series of measurements. The image processor further operates to construct a three-dimensional output image from the first and second images, where the number of measurement samples is less than the number of pixels in the output image.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram illustrating radiance of light to a point on a photosensor;

FIG. 2 is a diagram illustrating the light-field computation;

FIG. 3 is a diagram depicting an example arrangement for a three-dimensional hyperspectral imaging system;

FIG. 4 is a flowchart illustrating an example method for constructing a three-dimensional image which may be employed by the imaging system;

FIG. 5 is a diagram depicting an alternative arrangement for an imaging system which employs multiple photodetectors;

FIG. 6 is a flowchart illustrating an example method for constructing a three-dimensional image using the arrangement of FIG. 5;

FIG. 7 is a diagram depicting another arrangement for an imaging system for achieving higher resolution images;

FIGS. 8 and 9 are diagrams depicting an example object represented by thirty-six pixels and a labeling of each pixel;

FIGS. 10 and 11 are diagrams depicting how to a series of images are generated using the arrangement in FIG. 7; and

FIGS. 12 and 13 are diagrams generate illustrating how to calculate intensity values on an example pixel when constructing a higher resolution image.

Corresponding reference numerals indicate corresponding parts throughout the several views of the drawings.

### DETAILED DESCRIPTION

Example embodiments will now be described more fully with reference to the accompanying drawings.

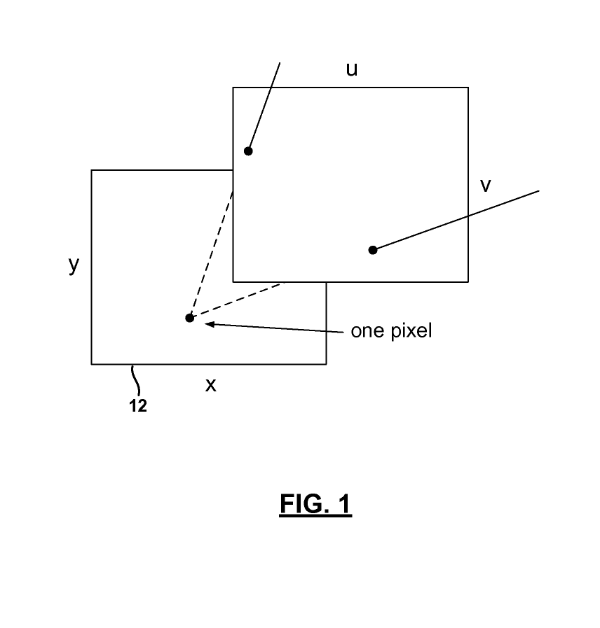

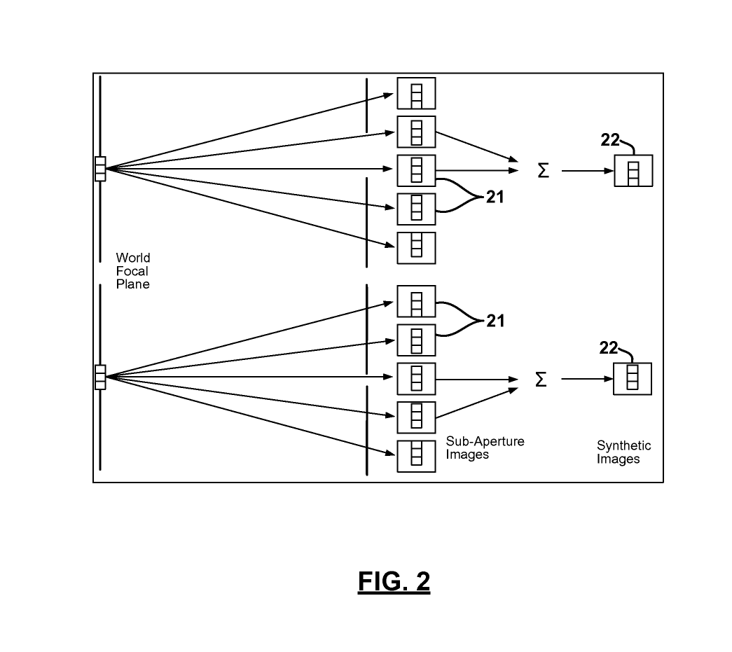

In a conventional imaging system, a photosensor array records the total intensity of different light rays arriving to each point on a sensor plane 12 as shown in FIG. 1, so the directional information of the light rays is neglected in most cases. However, this missing data of light rays contains a lot of information which is useful in many applications such as digital refocusing and 3D imaging. In computer graphics, the set of all light rays is called the light field. The basic idea of this disclosure is to use the recorded light rays information (including both intensity and direction), which can be represented by sub-aperture images 21, to compute a final image called a synthetic image 22 as shown in FIG. 2.

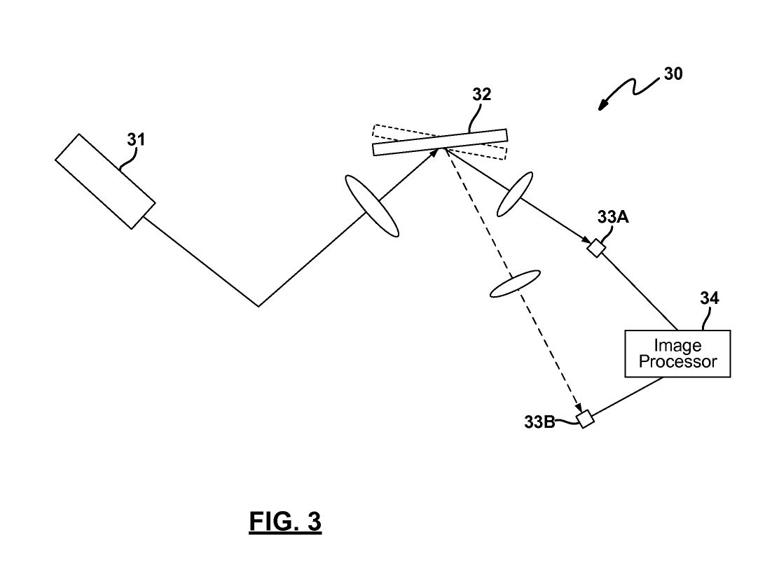

FIG. 3 depicts an example arrangement for a three-dimensional hyperspectral imaging system 30. The imaging system 30 is comprised generally of: an array of micromirrors 32, two photodetectors 33 and an image processor 34. The imaging system 30 may optionally include a light source 31. In the example embodiment, the light source 31 is an infrared laser. The infrared laser is used to project electromagnetic radiation onto a scene of interest. It is readily understood that other types of light sources can be used to illuminate the scene. In other embodiments, it is envisioned that the imaging system 30 may function without the use of a light source.

The array of micromirrors 32 is arranged to receive the electromagnetic radiation that is reflected from the scene. Each micromirror can be controlled independently between two states. In an on state, a given mirror in the array 32 directs electromagnetic radiation towards the two photodetectors such that the radiation forms image data of the scene. In an off state, a given mirror in the array 32 directs electromagnetic radiation elsewhere such that the radiation is excluded from the image data. The on/off states of the mirrors in the array are referred to collectively as a pattern. Accordingly, the on/off states of the mirrors in the array 32 can be configured in accordance with a given pattern. In the example embodiment, the array of micromirrors 32 is embodied as a digital micromirror device as is commercially available, for example from Texas Instruments Inc.

The first photodetector 33A is arranged to capture the image data reflected by the array of micromirrors 32 from a first point of view; whereas, the second photodetector 33B is arranged to receive the image data reflected by the array of micromirrors 32 from a second point of view. In the example embodiment, the photodetectors 33 are single-pixel devices. More specifically, the photodetectors include an active area comprised of a nanomaterial (e.g., carbon nanotube or graphene) and a metal contract electrode. When the nanomaterial is bridged between two metal electrodes, CNT/graphene-metal interfaces are formed at their contracts. When infrared photons hit the nanomaterial, the photons with energy bigger than the band gap excite electrons and holes inside the material to form electron-hole pairs. As a result, a high photocurrent can be induced. Further details regarding an exemplary photodetector may be found in “Development of Infrared Camera Using Graphene” by King Wai, et al, IEEE Nanotechnology Magazine, vol. 6, issue 1, pp. 4-7, 2012 which is incorporated in its entirety herein. It is understood that other types of photodetectors fall within the broader aspects of this disclosure.

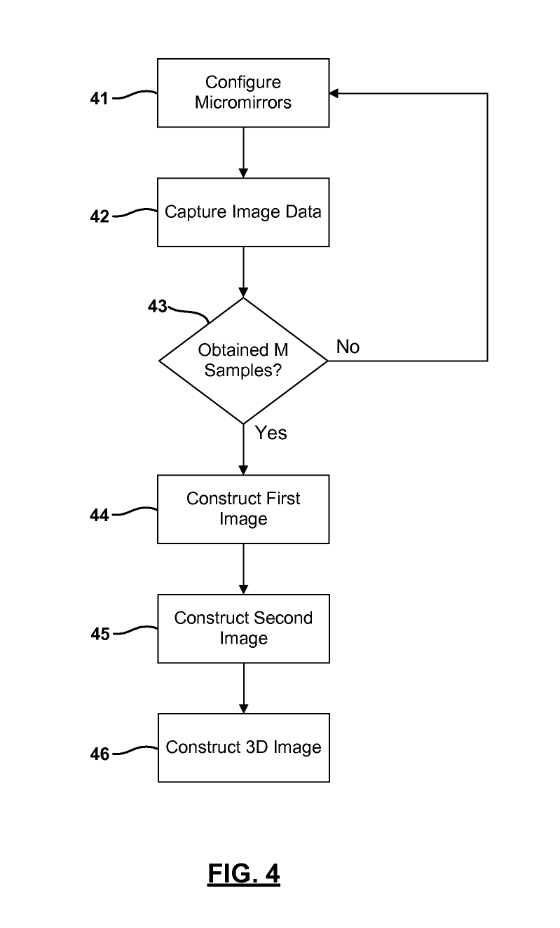

FIG. 4 further illustrates an example method undertaken to construct a three-dimensional image using the imaging system 30. To begin, the on/off state of each mirror in the array of micromirrors is configured at 41 in accordance with a predefined pattern. Image data from the scene is then captured at 42 by the first and second photodetectors 33A, 33B. A number of measurement samples M are needed to construct a sub-aperture image using compressive sensing as will be further explained below. Accordingly, these steps are repeated as indicated at 43 until M measurement samples are obtained. Of note, for each measurement sample, the array of micromirrors is reconfigured with a pattern that differs amongst each of the measurement samples.

During operation, the image processor 34 is configured to receive and store image data from both of the first and second photodetectors 33A, 33B. Upon obtaining each of measurement samples, the image processor 34 operates to construct a first image at 44 from image data captured by the first photodector and a second image at 45 from image data captured by the second photodetector. As a result, two images can be obtained from the two photodetectors 33A, 33B and they are considered as sub-aperture images for light-field computation. From the first and second images, the image processor 34 can then construct a three-dimensional output image, where the number of measurement samples is less than the number of pixels in the output image. In an example embodiment, the resolution of the recovered first and second images is 50×50 pixels and the number of measurement samples M is 1500 which is much smaller than the dimension of the image resolution (N=2500).

In a conventional digital imaging system, an array of photodetectors is made in the same focal plane to collect photons for imaging. In signal processing, it is known that a signal can be reconstructed based on the Nyquist-Shannon sampling theorem, i.e. the sampling frequency should exceed two times of the maximum frequency of the original signal. Therefore, the dimension of photosensor arrays will determine the spatial resolution of the image. However, it is difficult to increase the resolution of hyperspectral images by increasing the number of photosensor arrays. The challenges of increasing the number of photosensor arrays include the signal crosstalk problem among adjacent sensors, and moreover, hyperspectral sensors require collecting signals as a number of images which represents a range of the electromagnetic spectrum.

Instead of using conventional photosensor arrays for signal acquisition, a one single-pixel photosensor is employed in this disclosure and captured image data is reconstructed using compressive sensing. Based on the compressive sensing theory, a novel technique is developed to compress data during an acquisition process, and recover the original signal with less sampling data. Each measurement of compressive sensing is considered as the sum of linear projection of the original signals and the measurement matrix. By designing the measurement matrix properly, it enables the imaging system 30 to reconstruct the original signals by taking fewer measurement data.

A compressive sensing algorithm which can be employed by the imaging system 30 is explained below. Given an original signal x with its dimension equal to N, and compressive sensing takes M times linear measurements based on the measurement matrix φ, so the measurement result y can be obtained as the following equations,

y=φ×x (1)

Please note that the original signal is a sparse signal in this case. For the sparse signals, only a small number of the elements have the significant value while the other value are zero in x. Based on Eq. (1), the measurement matrix projects the original signal x into the measurement result y during each measurement, so infinite solutions of x can be obtained. Besides, the dimension of the measurement result y is equal to M which is much smaller than the dimension N of the original signal x, so we can consider the original signals are compressed into much smaller dimension. In case of a non-sparse signal, a “spasify” process is required to transform the non-sparse signal into a sparse signal by using some special basis, such as wavelet, curvelet and Fourier, as the following equations,

x=Ψ×s (2)

where s is the sparse representation of the non-sparse signal in basis W. By combining Eq. (2) with Eq. (1), the measurement result y of a non-sparse signal can be obtained as the following equation,

y=φ×Ψ×s (3)

Now, consider the image recovery process. When the original signal x is sparse, an optimization solution of x can be found by solving the minimization l₀ problem in Eq. (4).

\hat{x}=argmin∥x₀∥₀y=φ×x (4)

where \hat{x} is the reconstructed signal using the compressive sensing theory. However, the minimization l₀ is a NP-hard problem, so the minimization l₁ problem is commonly used in compressive sensing,

\hat{x}=argmin∥x∥₁y=φ×x (5)

Similarly, when the original signal is non-sparse, a new measurement matrix can be found as the following equation,

\tilde{φ}=φ×Ψ (6)

Then, the signal can be recovered by solving the minimization l₁ problem in Eq. (7),

\tilde{s}=argmin∥s∥₁y=φ×Ψ×s (7)

The core part of the compressive sensing is to perform the linear projection of the original signal to the measurement result using a proper measurement matrix.

In the example embodiment, a digital micromirror device (e.g., commercially available from DMD, Texas Instrument Inc. USA) is used to generate the measurement matrix. The digital micromirror device consists of an array of micromirrors. Each micromirror can be controlled independently to two different positions, so different patterns on the digital micromirror device are equivalent to different measurement matrix. When the light source signals illuminate on the digital micromirror device, a portion of the light signals can be reflected to different directions, which depends on the patterns generated by the micromirrors. The reflected signal is focused and aligned to the photodetector. Therefore, the photocurrent generated by the photodetector is the sum of the projection of the measurement matrix and the source signal. Based on the compressive sensing theory, the patterns of the digital micromirror device are required to be changed in each measurement, so that a series of measurement results can be obtained by measuring the photocurrent of the photodetector for each measurement. The original image x is then compressed into measurement result y with M times measurement which is much smaller than the dimension N of the original image x. Finally, an image 2 is recovered by solving the minimization l₁ problem based on Eq. (5). Therefore, the spatial resolution of the sub-aperture image is determined by the number of measurement (M). In the context of imaging system 30, this technique is applied to the series of measurement samples captured by the first photodetector to construct a first image and to the series of measurement samples captured by the second photodetector to construct a second image.

With continued reference to FIG. 3, a three-dimensional output image can be reconstructed from the first and second images. In the example imaging system 30, two photodetectors are employed and their positions are aligned to the reflected signal from the micromirror device, so that the reconstructed image on each photodetector represents the directional information of the signals. Based on the two offset images, a three dimensional image can be reconstructed using stereoscopic methods. In one example embodiment, the stereoscopic three-dimensional effect is achieved by means of an encoding of two images using, for example red and cyan filters. The anaglyph three-dimensional image contains two different filtered colored images and each colored image is presented to one eye. An integrated stereoscopic image can be viewed through a pair of anaglyph glasses. The visual cortex of the brain fuses the stereoscopic image into perception of a three dimensional scene or object.

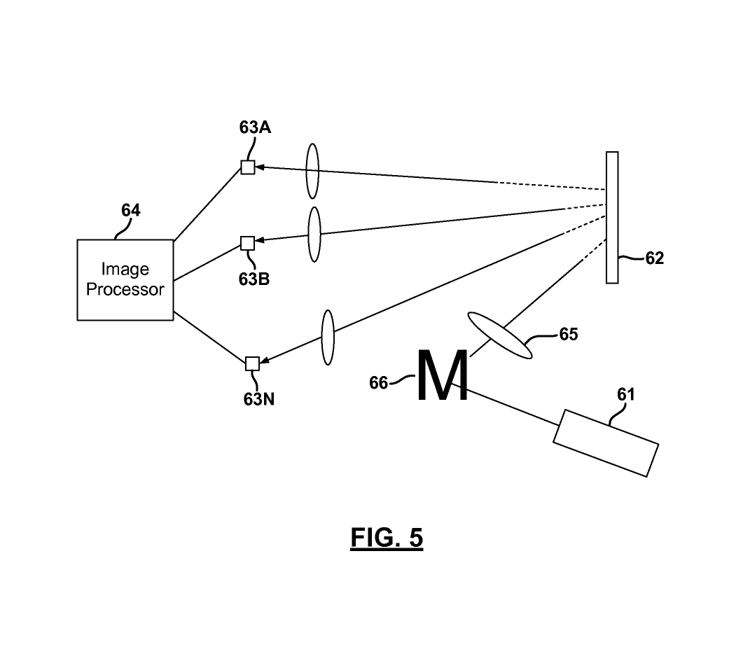

The extension of single-pixel imaging system could bring us the application of light field imaging. FIG. 5 depicts an example arrangement for a light field imaging system 60. The imaging system 60 is comprised generally of: a light source 61, a digital micromirrors array 62, a group of photodetectors 63 (63A to 63N), zoom lens 65 and an image processor 64. In the example embodiment, the light source 61 is an infrared light. The infrared light is used to project electromagnetic radiation onto a scene 66 of interest. It is readily understood that other types of light sources can be used to illuminate the scene.

The array of digital micromirrors 62 is arranged to reflect the electromagnetic radiation that is from the scene. Each micromirror can be controlled independently between two states. In an on state, a given mirror in the array 62 directs electromagnetic radiation towards the photodetectors such that the radiation forms image data of the scene. In an off state, a given mirror in the array 62 directs electromagnetic radiation elsewhere such that the radiation is excluded from the image data. The on/off states of the mirrors in the array are referred to collectively as a pattern. Accordingly, the on/off states of the mirrors in the array 62 can be configured in accordance with a given pattern. In the example embodiment, the array of micromirrors 62 is embodied as a digital micromirror device as is commercially available, for example from Texas Instruments Inc.

The first photodetector 63A is arranged to capture the image data reflected by the array of micromirrors 62 from a first point of view; whereas, the second photodetector 63B is arranged to receive the image data reflected by the array of micromirrors 62 from a second point of view, the Nth photodetector 63N is arranged to receive the image data reflected by the array of micromirrors 62 from a Nth point of view. In the example embodiment, the photodetectors 63 are single-pixel devices. More specifically, the photodetectors include an active area comprised of a nanomaterial (e.g., carbon nanotube or graphene) and a metal contract electrode. It is understood that other types of photodetectors fall within the broader aspects of this disclosure.

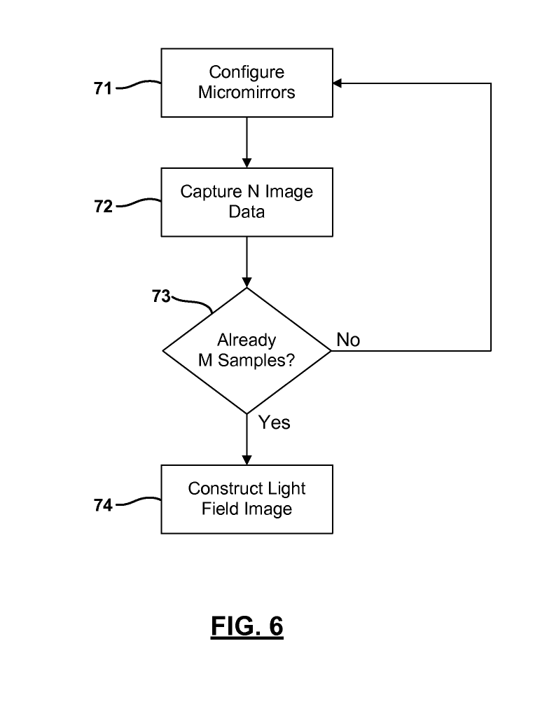

FIG. 6 further illustrates an example method undertaken to construct a light field image using the imaging system 60. To begin, the on/off state of each mirror in the array of micromirrors is configured at 71 in accordance with a predefined pattern. Image data from the scene is then captured at 72 by photodetectors 63A, 63B to 63N. A number of measurement samples M are needed to construct a sub-aperture image using compressive sensing as was described above. Accordingly, these steps are repeated as indicated at 73 until M measurement samples are obtained. Of note, for each measurement sample, the array of micromirrors is reconfigured with a pattern that differs amongst each of the measurement samples.

During operation, the image processor 64 is configured to receive and store image data from all photodetectors 63A, 63B to 63N. Upon obtaining each of measurement samples, the image processor 64 operates to construct a first image at 64 from image data captured by the photodectors 63A, 63B to 63N at 74. As a result, there are N sub-aperture images from one round measurement, and they are considered as sub-aperture images for light-field computation. From N recovery images, the image processor 64 can then construct a light field output image, where the number of measurement samples is less than the number of pixels in the output image. In an example embodiment, the resolution of the recovered images is 64×64 pixels and the number of measurement samples M is 1500 which is much smaller than the dimension of the image resolution (N=4096).

In a conventional digital imaging system, an array of photodetectors is made in the same focal plane to collect photons for imaging. In signal processing, it is known that a signal can be reconstructed based on the Nyquist-Shannon sampling theorem, i.e. the sampling frequency should exceed two times of the maximum frequency of the original signal. Therefore, the dimension of photosensor arrays will determine the spatial resolution of the image. However, it is difficult to increase the resolution of hyperspectral images by increasing the number of photosensor arrays. The challenges of increasing the number of photosensor arrays include the signal crosstalk problem among adjacent sensors, and moreover, hyperspectral sensors require collecting signals as a number of images which represents a range of the electromagnetic spectrum.

Instead of using conventional photosensor arrays for signal acquisition, a one single-pixel photosensor is employed in this disclosure and captured image data is reconstructed using compressive sensing. Based on the compressive sensing theory, a novel technique is developed to compress data during an acquisition process, and recover the original signal with less sampling data. Each measurement of compressive sensing is considered as the sum of linear projection of the original signals and the measurement matrix. By designing the measurement matrix properly, it enables the imaging system 60 to reconstruct the original signals by taking fewer measurement data.

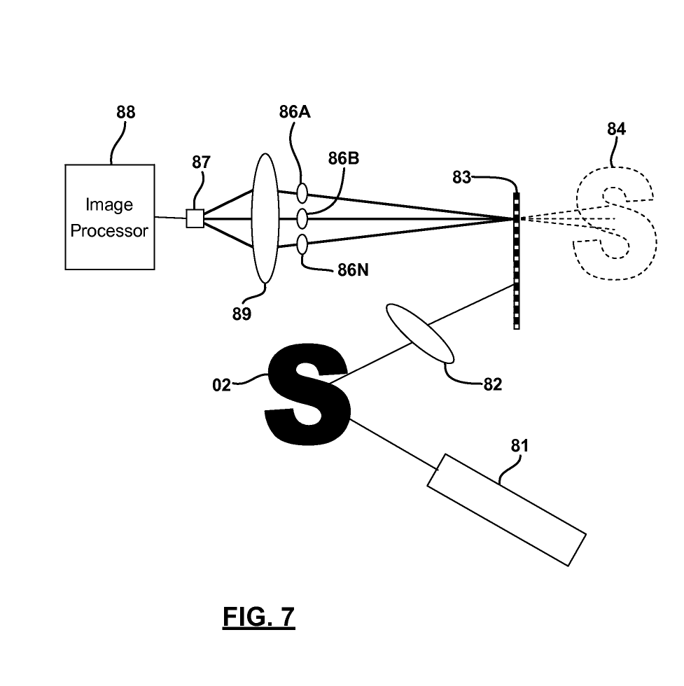

To achieve higher resolution imaging, an electrical mask 86 is introduced. The electrical mask/aperture is inserted in the optical path as shown in FIG. 7. By employing the electrical mask, apertures 86A, 86B . . . 86N can be controlled to open or close in different positions, so the optical paths are adjusted. As a result, the nanodectector 87 reconstruct images based on the light signal from different angular directions. Each individual image can be considered as a sub-image, because the light signals are coming from the same target source. Accordingly, integration of the sub-images will achieve a higher resolution image of the same target. For example, the photodetector 87 will capture multiple images from different apertures 86A to 86N. As a result, a series of sub-images are collected. A single final high resolution image can be reconstructed in the image processor 88 by combing the sub-images through the recovery method as will be further described below.

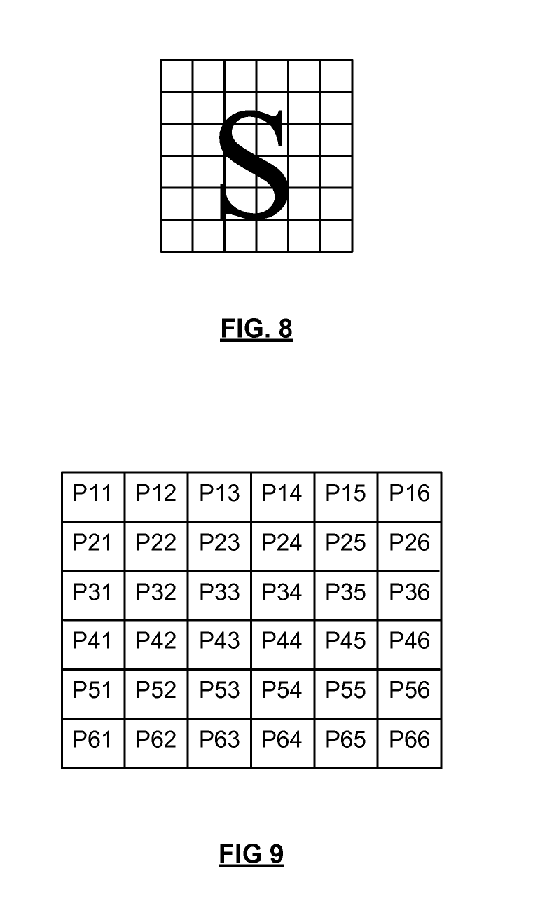

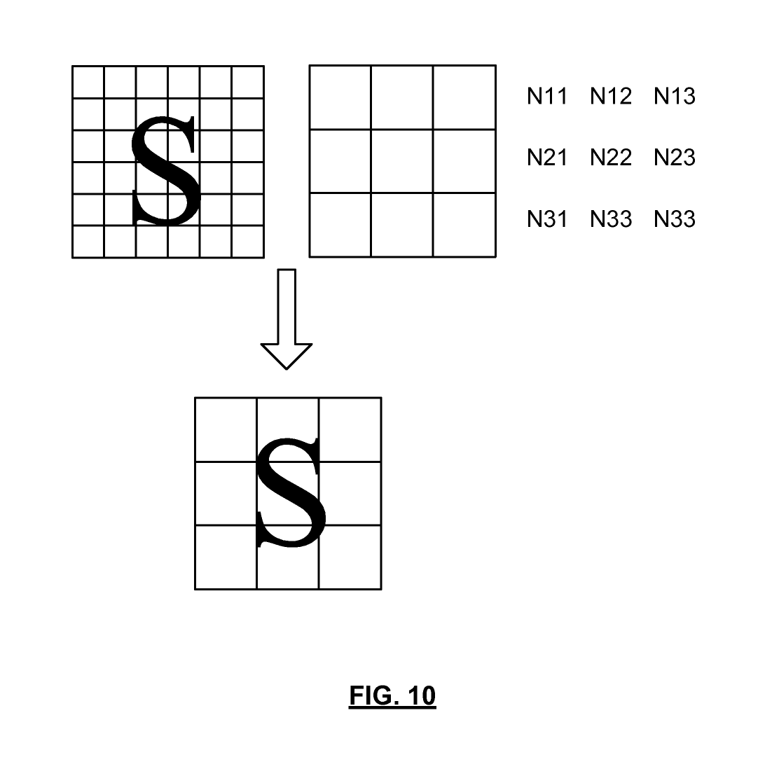

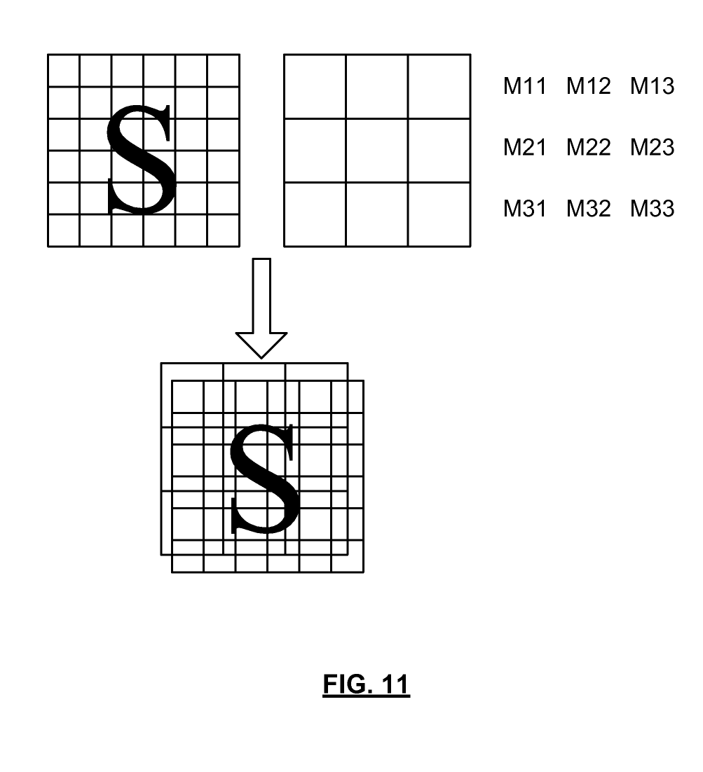

In the first step, start with an original object as shown in FIG. 8. For illustration purposes, assume the object is to be represented by 36 pixels (6×6). In order to explain, each pixel is marked as shown in FIG. 9. However, assume the camera has only 3×3 pixel sensors. Next, use this 3×3 camera to capture the object as shown in FIG. 10. N11 is measuring the area of sum (P11+P12+P21+P22)
N12 is measuring the area of sum(P13+P14+P23+P24)
N33 is measuring the area of sum(P55+P56+P65+P66)
   To obtain a second angular image, the camera is moved slightly. In second angular image, M11 pixel cover P11, partial of P12, partial of P21 and partial of P22 as seen in FIG. 11. Likewise, M12 pixel cover partial of P12, P13 and partial of P14, partial of P22, partial of P23, partial of P24. Similar mappings apply to each of the pixels until reaching M33 which partially covers P66, partial of P65, partial of P64, partial of P56, partial of P54, P55, partial of P46, partial of P45, partial of P44. This process is repeated many times to obtain additional angular images, each angular image has sub pixel differences as illustrated in FIGS. 10 and 11.

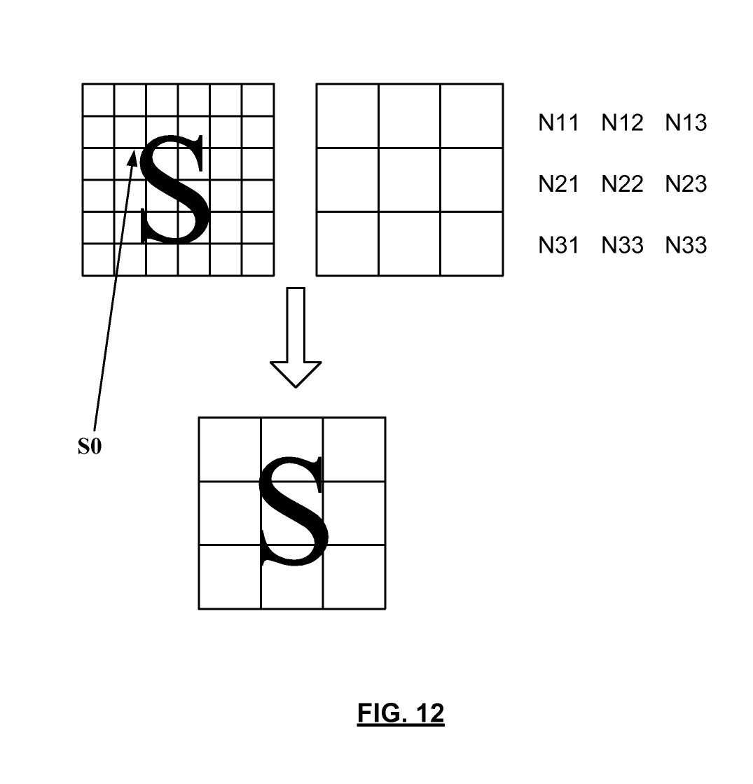

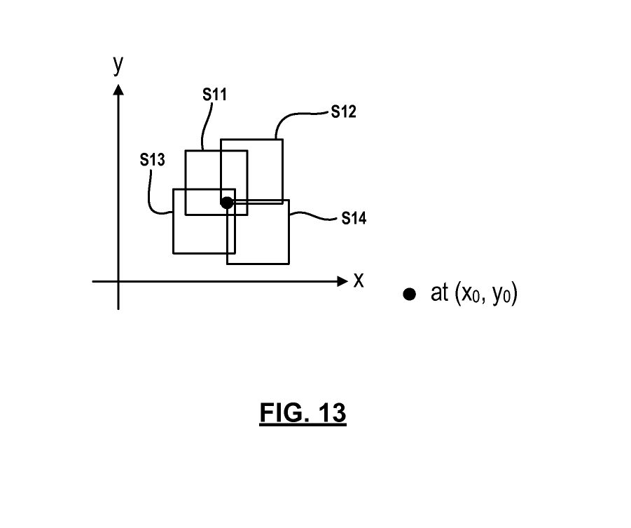

From this series of angular images, a single final high resolution image can be reconstructed. With reference to FIG. 12, an example point, S0 (x0, y0), in the image is selected. The intensity value at position S0={x+x0, y+y0} is approximated by a polynomial expansion:

fₛ_{₀}(x,y)=p₀+p₁x+p₂y+p₃x²+p₄xy+p₅y²+ (8)

In an example embodiment, polynomial basis was used in analysis. However, the measurement for each pixel cover a large area in low resolution, it is the integration at the neighborhood of center circle of (x0, y0).

I=∫∫fₛ_{₀}(x,y)dxdy=c₀+p₀xy+p₁x²y+p₂xy²+p₃x³y+p₄x²y²+p₅xy³+ (9)

As shown in FIG. 13, S11, S12, S13 and S14 can be calculated by:

$$\begin{matrix}\begin{matrix}\begin{matrix}S 11 \\ S 12\end{matrix} \\ S 13\end{matrix} \\ S 14\end{matrix} = [ \begin{matrix}{∮}_{S 11} {f}_{s 0} ( x , y ) d x d y \\ {∮}_{S 12} {f}_{s 0} ( x , y ) d x d y \\ {∮}_{S 13} {f}_{s 0} ( x , y ) d x d y \\ {∮}_{S 14} {f}_{s 0} ( x , y ) d x d y\end{matrix} ]$$

In this example, S11, S12, S13 and S14 are from 4 different angular low resolution image. This matrix can be re-written as

P*X=I

where P is coefficient of equation (9) and I is low resolution value. This function can be linear or NP problem. Linear means the unknowns is same as number of measurements. For example, four functions with four unknowns (i.e., four coefficients). However, they can be optimized by high order interpolation. For example, four angular images with eight unknowns. There are many high level algorithms used here. For example, least squares estimation, L2 minimization was applied to get a unique solution. Other types of algorithms can also be applied to be a solution. This process is repeated for each position of the image to thereby create a higher resolution image.

Image processing techniques described herein may be implemented by one or more computer programs executed by one or more image processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method for constructing a three-dimensional hyperspectral image using compressive sensing, comprising:
(a) configuring on/off state of each mirror in an array of micromirrors in accordance with a pattern;
(b) capturing image data of a scene from a first point of view using a first photodetector, where the image data is directed by the array of micromirrors to first photodetector;
(c) capturing image data of the scene from second point of view using a second photodetector, where second point of view differs from the first point of view and the image data is directed by the array of micromirrors to second photodetector;
(d) repeating steps (a)-(c) to obtain a series of measurement samples, where the array of micromirrors is configured in accordance with a pattern that differs amongst each measurement samples;
(e) constructing a first image from the series of measurement samples captured by the first photodetector using compressive sensing;
(f) constructing a second image from the series of measurement samples captured by the second photodetector using compressive sensing; and
(g) constructing a three-dimensional output image from the first and second images, where the number of measurement samples is less than pixels of the output image.

2. The method of claim 1 wherein constructing the first image further comprises performing a linear projection of first image to measurement samples from the first photodetector using a measurement matrix, where the measurement matrix is derived from the patterns of the array of micromirrors used to capture the measurement samples.

3. The method of claim 2 wherein constructing the first image further comprises determining the first image by solving a minimization problem using the measurement samples from the first photodetector and corresponding patterns for the array of micromirrors.

4. The method of claim 1 further comprises illuminating the scene using an infrared light source.

5. The method of claim 1 further comprises capturing image data wherein at least one of the first photodetector and the second photodetector are single-pixel devices having an active area comprised of a nanomaterial.

6. The method of claim 1 further comprises embodying the array of micromirrors as a digital micromirror device.

7. The method of claim 1 wherein constructing the three-dimensional output image further comprises combining the first and second images using a stereoscopic method.

8. The method of claim 7 further comprises encoding the first image using a first color filter, encoding the second image using a second color filter, and presenting each encoded image separately.

9. The method of claim 7 further comprises producing the first image and second image using different polarizating filters, and presenting each encoded image separately.

10. A three-dimensional hyperspectral image system, comprising:
an array of micromirrors arranged to receive the electromagnetic radiation reflected from a scene, each mirror in the array of micromirrors is selectively configurable between an on state and an off state, such that electromagnetic radiation directed by mirrors in an on state form image data from the scene and electromagnetic radiation directed by mirrors in an off state is excluded from the image data;
a first photodetector arranged to capture the image data reflected by the array of micromirrors from a first point of view;
a second photodetector arranged to receive the image data reflected by the array of micromirrors from a second point of view; and
an image processor configured to receive image data from the first and second photodetectors and operates to construct a first image from image data captured by the first photodector over a series of measurements and to construct a second image from image data captured by the second photodetector over a series of measurements, where the first and second images are constructed using compressive sensing and the on/off state of each mirror in the array of micromirrors is configured in accordance with a pattern that differ amongst each measurement in the series of measurements,
the image processor further operates to construct a three-dimensional output image from the first and second images, where the number of measurement samples is less than the number of pixels n the output image.

11. The image system of claim 10 wherein the image processor performs a linear projection of the first image to measurement samples from the first photodetector using a measurement matrix, where the measurement matrix is derived from the patterns of the array of micromirrors used to capture the measurement samples.

12. The image system of claim 11 wherein the image processor determines the first image by solving a minimization problem using the measurement samples from the first photodetector and corresponding patterns for the array of micromirrors.

13. The imaging system of claim 11 further includes a light source configured to project electromagnetic radiation towards the scene, where the light source is further defined as an infrared light source.

14. The image system of claim 10 wherein at least one of the first photodetector and the second photodetector is a single-pixel device having an active area comprised of a nanomaterial.

15. The image system of claim 10 wherein the array of micromirrors is further defined as a digital micromirror device.

16. The image system of claim 10 wherein the image processor constructs the three-dimensional output image by combining the first and second images using a stereoscopic method.

17. A method for constructing a three-dimensional hyperspectral image using compressive sensing, comprising:
(a) configuring on/off state of each mirror in an array of micromirrors in accordance with a pattern;
(b) capturing electromagnetic radiation indicative of a scene using a photodetector, where electromagnetic radiation reflected from the scene is directed by the array of micromirrors via a mask to a photodetector and the mask includes a plurality of apertures;
(c) repeating steps (a) and (b) to obtain a series of measurement samples, where the array of micromirrors is configured in accordance with a pattern that differs amongst each measurement samples;
(d) constructing a first sub-image from the series of measurement samples using compressive sensing, where the first sub-image is derived from electromagnetic radiation received from a first aperture in the plurality of apertures;
(e) constructing a second sub-image from the series of measurement samples using compressive sensing, where the second sub-image is derived from electromagnetic radiation received from a second aperture in the plurality of apertures; and
(f) constructing a three-dimensional output image by combining the first sub-image with the second sub-image, where the number of measurement samples is less than pixels of the output image.

18. The method of claim 17 further comprises illuminating the scene using an infrared light source.

19. The method of claim 17 wherein the photodetector is further defined as a single-pixel device having an active area comprised of a nanomaterial.

20. The method of claim 17 further comprises embodying the array of micromirrors as a digital micromirror device.

21. The method of claim 17 further comprises selectively controlling electromagnetic radiation passing through the plurality of apertures to construct the first and second sub-images.

22. The method of claim 17 further comprises by combining the first sub-image with the second sub-image using a least squares estimation method.

23. A three-dimensional hyperspectral image system, comprising:
an array of micromirrors arranged to receive the electromagnetic radiation reflected from a scene, each mirror in the array of micromirrors is selectively configurable between an on state and an off state, such that electromagnetic radiation directed by mirrors in an on state forms image data from the scene and electromagnetic radiation directed by mirrors in an off state is excluded from the image data;
a photodetector arranged to capture the image data reflected by the array of micromirrors;
a mask interposed between the array of micromirrors and the photodetector, the mask having a plurality of apertures selectively controlled to pass image data from the array of micromirrors therethrough to the photodetector; and
an image processor configured to receive image data from the photodetector over a series of measurement samples, where the array of micromirrors is configured in accordance with a pattern that differs amongst each measurement sample in the series of measurement samples, and operates to construct a series of sub-images from the series of measurement samples using compressive sensing, where each sub-image in the series of sub-images is derived from image data received from a different aperture in the plurality of apertures;
the image processor further operates to construct a three-dimensional output image from the series of sub-images, where the number of measurement samples is less than the number of pixels in the output image.

24. The imaging system of claim 23 further includes a light source configured to project electromagnetic radiation towards the scene, where the light source is further defined as an infrared light source.

25. The image system of claim 23 wherein the photodetector is further defined as a single-pixel device having an active area comprised of a nanomaterial.

26. The image system of claim 23 wherein the array of micromirrors is further defined as a digital micromirror device.

27. The image system of claim 23 wherein the image processor combines the series of sub-images using a least squares estimation method.
